(19) United States
(12) Patent Application Publication
(10) Pub. No.: US 2003/0075428 A1
(43) Pub. Date: Apr. 24, 2003

(54) Electrical switches

(76) Inventor: Tsutomu Takenaka, Tokyo (JP)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/273,021

(22) Filed: Oct. 17, 2002

(30) Foreign Application Priority Data
Oct. 19, 2001 (JP) 2001-321594

(51) Int. Cl. H01H 29/00

(52) U.S. Cl. 200/182

(57) ABSTRACT

Electrical switches are described. In one aspect, an electrical switch includes a closed-loop fluid channel, multiple electrodes, and a pressure control system. The closed-loop fluid channel contains an electrically-conductive fluid and an electrically-insulating fluid. Each of the electrodes is in contact with fluid within the fluid channel at a respective location. The pressure control system is operable to change relative fluid pressure within the fluid channel at locations between adjacent electrodes to control splitting of a contiguous region of electrically-conductive fluid electrically connecting a pair of adjacent electrodes and merging of split regions of electrically-conductive fluid.

### CROSS-REFERENCE TO RELATED APPLICATIONS

Under 35 U.S.C. §119 this application claims the benefit of co-pending Japanese Patent Application No. 2001-321594, which was filed Oct. 19, 2001, and is incorporated herein by reference.

### BACKGROUND

A wide variety of different electrical switches has been proposed. In a reed relay switch, a miniature glass vessel contains an inert gas and two magnetic alloy leads. A coil of an electromagnetic drive is wound around the reed relay. In a typical configuration, when the coil is not energized, the ends of the leads repel each other so that the switch is open. When the coil is energized, the ends of the leads attract each other to close the switch. A reed relay may be implemented as a dry reed relay or a wet reed relay. Dry reed relays typically have high contact resistance and relatively low reliability because of considerable wear at the lead contacts. In a wet reed relay, the contact surfaces of the leads are covered with mercury, which decreases the friction-based wear of the lead contacts.

Another type of electrical switch includes a plurality of electrodes that are disposed for fluid contact at specific locations along the inner walls of an electrically-insulating sealed channel that is filled with a small volume of an electrically-conductive liquid. Two electrodes are connected together electrically when the electrically-conductive liquid forms a continuous, electrically-conductive path between the pair of electrodes. The electrical connection between the electrodes is broken when the continuous, electrically-conductive path between the pair of electrodes is broken. A continuous volume of the electrically-conductive liquid may be moved into and out of contact with the pair of electrodes by creating a pressure differential across the liquid column in the channel. The pressure differential may be created by varying the volume of a gas supplied from a compartment located on one side of the liquid column, such as with a diaphragm or by heating the gas in the gas compartment.

To avoid the risk that the electrode surfaces might be corroded by components of the gas inside the channel, U.S. Pat. No. 6,323,447 (assigned to Agilent Technologies, Inc.) has proposed an electrical switch in which the electrodes are covered by electrically-conductive fluid at all times. This electrical switch has a cavity, two solid electrodes, an electrically-conductive fluid, and a form modification unit. The solid electrodes are separated from each other within the cavity containing the electrically-conductive fluid. The electrodes are in a “closed” state when the conductive fluid is in a contiguous form and in an “open” state when the conductive fluid is in a non-contiguous form.

### SUMMARY

The invention enables multiple electrode pairs to be switched in an electrical switch having a compact form factor. The invention also features electrical switches that are characterized by low distortion, low insertion loss, and broadband frequency response at high frequencies (e.g., microwave and milliwave wavelength regions).

In one aspect, the invention features an electrical switch that includes a closed-loop fluid channel, multiple electrodes, and a pressure control system. The closed-loop fluid channel contains an electrically-conductive fluid and an electrically-insulating fluid. Each of the electrodes is in contact with fluid within the fluid channel at a respective location. The pressure control system is operable to change relative fluid pressure within the fluid channel at locations between adjacent electrodes to control splitting of a contiguous region of electrically-conductive fluid electrically connecting a pair of adjacent electrodes and merging of split regions of electrically-conductive fluid.

Other features and advantages of the invention will become apparent from the following description, including the drawings and the claims.

### DESCRIPTION OF DRAWINGS

FIG. 1A is diagrammatic view of an electrical switch in a first switch state.

FIG. 1B is a circuit diagram of the electrical switch of FIG. 1A.

FIG. 2A is a diagrammatic view of the electrical switch of FIG. 1A in a second switch state.

FIG. 2B is a circuit diagram of the electrical switch of FIG. 2A.

FIG. 3A is a diagrammatic view of an electrical switch in a first switch state.

FIG. 3B is a diagrammatic view of the electrical switch of FIG. 3A in a second switch state.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

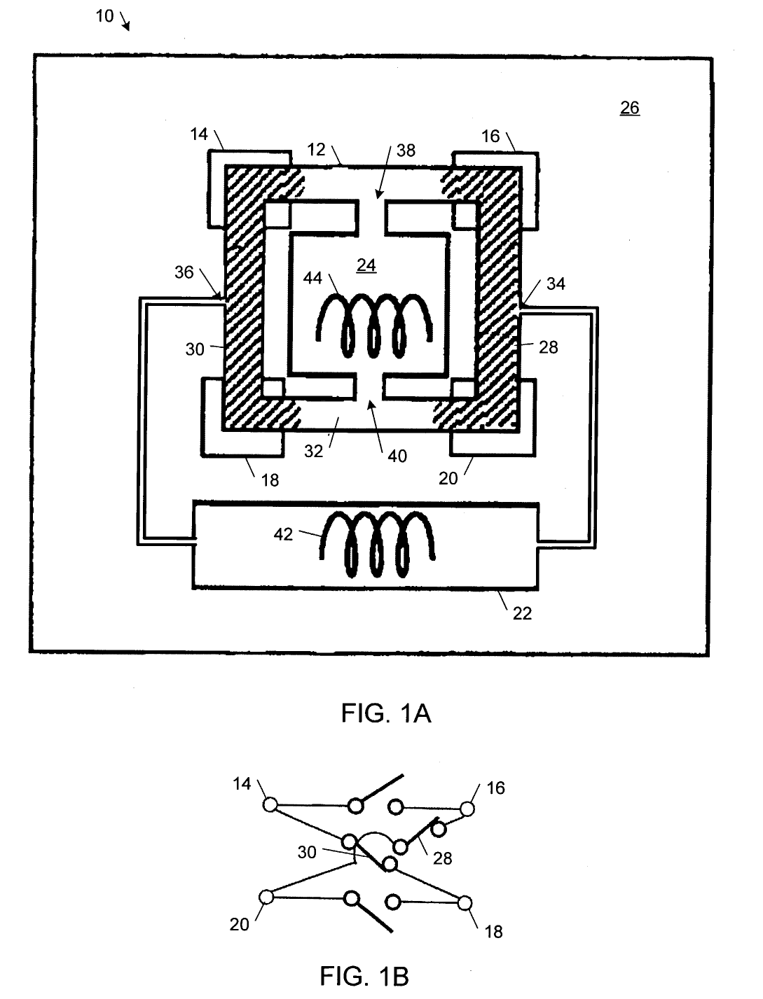

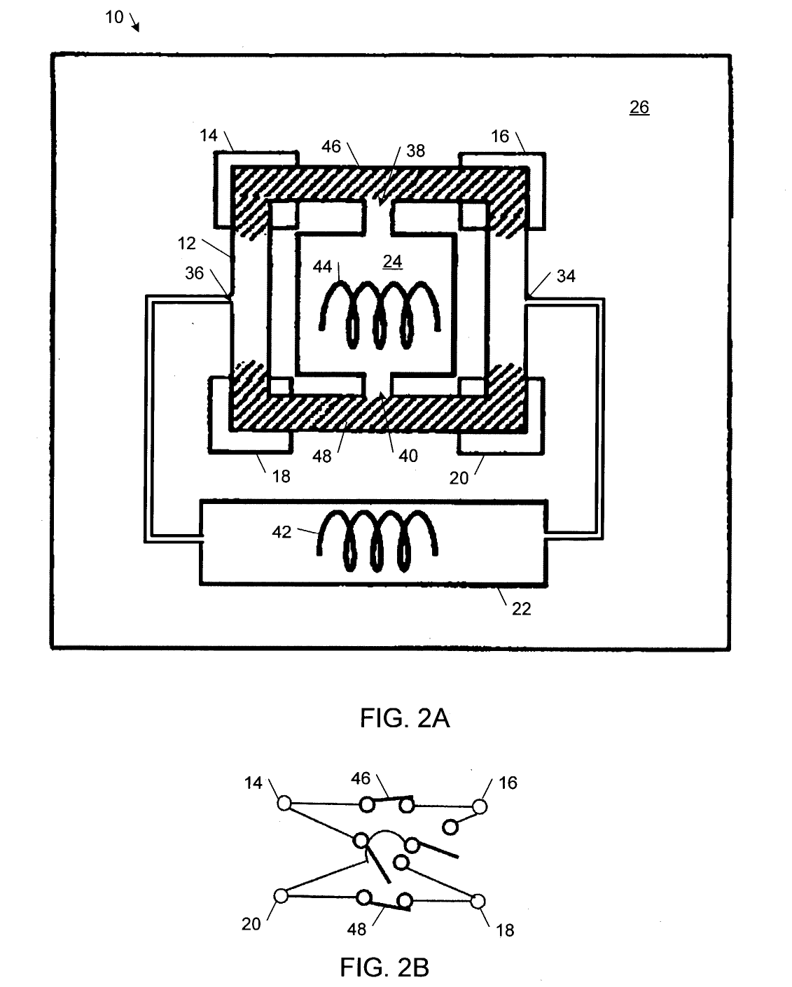

Referring to FIGS. 1A, 1B, 2A, and 2B, in one embodiment that is operable as a double-pole changeover switch, an electrical switch 10 includes a closed-loop fluid channel 12, multiple electrodes 14, 16, 18, 20, and a pressure control system that includes a pair of reservoirs 22, 24.

Fluid channel 12 is defined in a base 26, which is made of electrically-insulating material. In some embodiments, base 26 is made by laminating together two electrically-insulating substrates with the fluid channel being defined by matching, opposed grooves or channels in the substrates. The resulting structure is sealed to prevent leakage of fluid from fluid channel 12. The two substrates may be made of the same material or different materials. For example, in some embodiments the substrates may be made of different materials, such as a ceramic substrate and a glass substrate. Fluid channel 12 contains an electrically-conductive fluid that is split into two volumes 28, 30 (shown hatched); an electrically-insulating fluid 32 (shown in white) fills the remaing areas of fluid channel 12. The electrically-conductive fluid may be formed of a liquid metal (e.g., mercury, gallium, or sodium-potassium). The electrically-insulating fluid 32 may be an inert gas (e.g., a gas containing one or more of nitrogen, argon, and helium) or a vaporizable liquid (e.g., a liquid including one or more of a fluorocarbon, an oil, an alcohol, and water).

In the illustrated embodiment, the fluid channel 12 is substantially square, and the electrodes 14-20 are provided at the substantially L-shaped corners of fluid channel 12. Each electrode 14-20 has a respective contact point that is disposed for contact with the electrically-conducting fluid at a respective location within the fluid channel 12. The electrodes 14-20 preferably are formed from a material (e.g., a metal including one or more of tungsten, molybdenum, chromium, titanium, tantalum, iron, nickel, palladium, and platinum) that has good wettability with respect to the electrically-conductive fluid. As described in detail below, in operation, when the electrically-insulating fluid 32 is moved or deformed, the wettability of electrodes 14-20 with respect to the electrically-conducting fluid protects the electrodes 14-20 against damage or corrosion that otherwise might occur from exposure to electrically-insulating fluid 32 because the electrode surfaces are covered by electrically-conductive fluid at all times during switching operations. In addition, the wettability of electrodes 14-20 with respect to the electrically-conducting fluid and the surface tension of the electrically-conductive fluid cooperate to latch the electrical switch 10 in an open- or closed-state.

Reservoirs 22, 24 of the pressure control system are defined by cavities in base 26. In the illustrated embodiment, reservoir 22 is located outside of fluid channel 12 and reservoir 24 is circumscribed by fluid channel 12. Reservoir 22 is coupled to fluid channel 12 through two fluid ports 34, 36 that are located respectively between contact points of two pairs (16, 20 and 14, 18) of adjacent electrodes, with no electrode in common between the electrode pairs. Similarly, reservoir 24 is coupled to fluid channel 12 through two fluid ports 38, 40 that are located respectively between contact points of two pairs (14, 16 and 18, 20) of adjacent electrodes, with no electrode in common between the electrode pairs. In the illustrated embodiment, the dimensions of ports 34-40 are small enough to prevent electrically-conducting fluid from flowing out of channel 12 through ports 34-40. Reservoirs 22, 24 each contain a respective heating element 42, 44 that may be operated independently to heat the electrically-insulating fluid contained within the reservoirs 22, 24 and change the state of the switch.

Referring to FIGS. 1A and 1B, in one state of electrical switch 10, the circuits defined by electrode pair 14, 18 and electrode pair 16, 20 are closed by electrically-conductive fluid volumes 36, 34, respectively, whereas the circuits defined by electrode pair 14, 16 and 18, 20 are open as a result of the presence of electrically-insulating fluid between the electrodes of each electrode pair 14, 16 and 18, 20.

Referring to FIGS. 2A and 2B, when a bias is applied to heater 42, the resulting thermal energy causes non-conductive fluid inside reservoir 22 to expand or to undergo a transition from the liquid phase to the vapor phase, producing a positive pressure with respect to reservoir 24. This positive pressure acts on the electrically-conductive fluid volumes 28, 30 through ports 34, 36, causing each of the electrically-conductive fluid volumes 28, 30 to split into two substantially equal parts in fluid channel 12. The split portions of the electrically-conductive fluid volumes 28, 30 are moved and deformed, forcing electrically-insulating fluid located between electrodes 14, 16 and electrodes 18, 20 into reservoir 24. The resulting split portions of the electrically-conductive fluid volumes 28, 30 merge to form two continuous electrically-conductive fluid volumes 46, 48. In this second state of electrical switch 10, the circuits defined by electrode pair 14, 16 and electrode pair 18, 20 are closed by electrically-conductive fluid volumes 46, 48, respectively, whereas the circuits defined by electrode pair 14, 18 and electrode pair 16, 20 are open as a result of the presence of electrically-insulating fluid between the electrodes of each electrode pair 14, 18 and 16, 20. Reservoirs 22, 24 are designed so that even after the bias has been removed from the heater 42, the surface tension of the electrically-conductive fluid volumes 46, 48 overcomes the pressure exerted by the gas inside reservoir 24.

The electrical switch 10 is switched back to the state of FIGS. 1A and 1B, as follows. When a bias is applied to heater 44, electrically-insulating fluid inside reservoir 24 expands or undergoes a transition from the liquid phase to the vapor phase, producing a positive pressure with respect to reservoir 22. This positive pressure acts on the electrically-conductive fluid volumes 46, 48 through ports 38, 40, causing each of the electrically-conductive fluid volumes 46, 48 to split into two substantially equal parts in fluid channel 12. The split portions of the electrically-conductive fluid volumes 46, 48 are moved and deformed, forcing electrically-insulating fluid located between electrodes 14, 18 and electrodes 16, 20 into reservoir 22. The resulting split portions of the electrically-conductive fluid volumes 46, 48 merge to form the original continuous electrically-conductive fluid volumes 28, 30 (see FIG. 1A).

As shown in FIGS. 1A and 2A, in the illustrated embodiment, the electrically-conductive fluid preferably has a volume that substantially matches the volume needed to form continuous, electrically-conductive paths between two pairs of electrodes. In this way, when an electrical path is opened or closed by the movement of electrically-conductive fluid, the conduction path physically disappears with respect to the open circuit paths, and only physically appears in the required size in the closed circuit paths. This eliminates the parasitic inductance that otherwise would be present in the open circuit paths as a result of residual electrically-conductive fluid operating as open stubs. This feature improves the frequency response of electrical switch 10. For example, this feature makes it possible to achieve a flat frequency response even at high frequencies (e.g., microwave and milliwave frequencies) In addition, the distances between the electrode pairs and the volume of the electrically-conducting fluid are selected so that the electrode contact points remain covered by electrically-conducting fluid at all times during the switching operations. This feature protects the electrode contact point surfaces against possible corrosion or damage that otherwise might result from exposure to the electrically-insulating fluid.

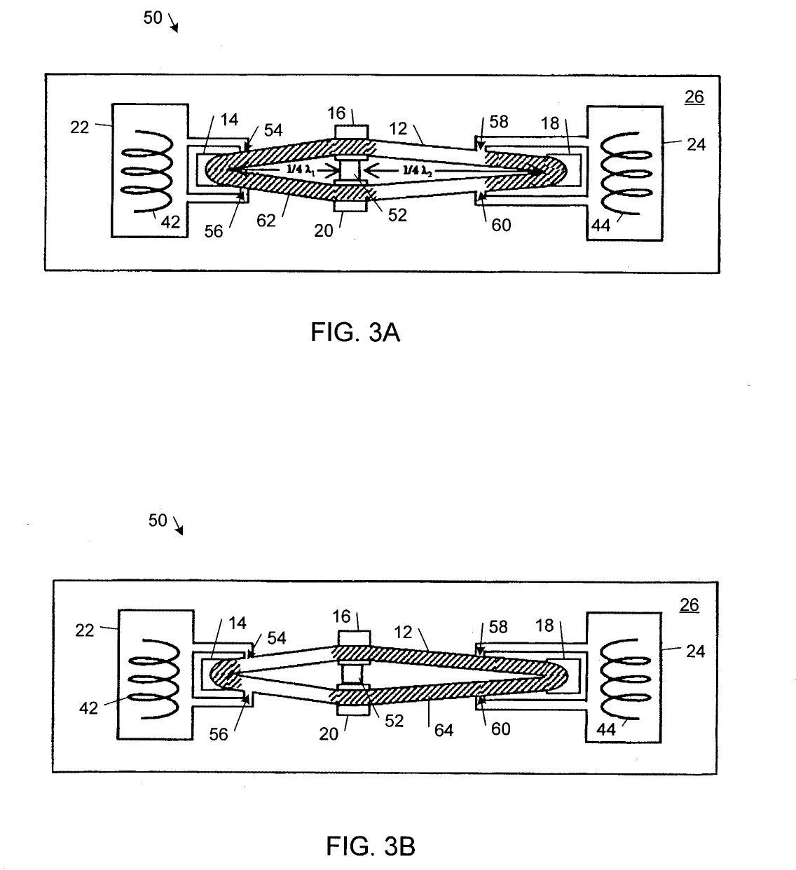

Referring to FIGS. 3A and 3B, in an embodiment that is operable as a power merger/splitter switch, an electrical switch 50 includes a closed-loop fluid channel 12, multiple electrodes 14, 16, 18, 20, and a pressure control system that includes a pair of reservoirs 22, 24. Each of the elements of electrical switch 50 may be implemented in the same way as the corresponding elements of electrical switch 10, except for the configuration of the pressure control system, the arrangement of the electrodes 14-20, and the inclusion of a resistor 52 that is coupled between electrodes 16 and 20, as explained in detail below.

Reservoir 22 is coupled to fluid channel 12 through two fluid ports 54, 56 that are located respectively between contact points of two pairs (14, 16 and 14, 20) of adjacent electrodes that share a common electrode (i.e., electrode 14). Similarly, reservoir 24 is coupled to fluid channel 12 through two fluid ports 58, 60 that are located respectively between contact points of two pairs (16, 18 and 18, 20) of adjacent electrodes that share a common electrode (i.e., electrode 18).

In the illustrated embodiment, each of the electrodes 16, 20 is spaced from electrode 18 by a distance of one-quarter the wavelength (λ₁) corresponding to a target signal frequency f₁, and the width and height of the channel 12 is selected so that the characteristic impedance of the electrical path produced by the electrically-conductive fluid volume 62 is Z₀. The electrodes 16, 20 are electrically connected together by resistor 52, which has a resistance value of \sqrt{2}Z₀. The resulting structure operates as a Wilkinson divider that provides a uniform power splitter/merger function with isolation characteristics between the electrodes 16, 20.

In the illustrated embodiment, each of the electrodes 16, 20 is spaced from electrode 14 by a distance of one-quarter the wavelength (λ₂) corresponding to a target signal frequency f₂, creating another Wilkinson divider that may be used with a different signal frequency f₂. In this configuration, electrical switch 50 may be incorporated in a circuit in which signal sources of different frequencies are selected, while the power of these signals is divided in two before being outputted.

Referring to FIG. 3A, in one state of electrical switch 50, the circuits that are defined by electrode pair 14, 16 and electrode pair 14, 20 are closed by electrically-conductive fluid volume 62, whereas the circuits defined by electrode pair 16, 18 and 18, 20 are open as a result of the presence of electrically-insulating fluid between the electrodes of each electrode pair 16, 18 and 18, 20.

Referring to FIGS. 3A and 3B, when a bias is applied to heater 42, the resulting thermal energy causes non-conductive fluid inside reservoir 22 to expand or to undergo a transition from the liquid phase to the vapor phase, producing a positive pressure with respect to reservoir 24. This positive pressure acts on the electrically-conductive fluid volume 62 through ports 54, 56, causing each of the electrically-conductive fluid volume 62 to split into three volumes: two substantially equal parts and a residual part that remains at electrode 14 to protect electrode 14 against exposure to electrically-insulating fluid. The substantially equal split portions of the electrically-conductive fluid volume 62 are moved and deformed, forcing electrically-insulating fluid located between electrodes 16, 18 and electrodes 18, 20 into reservoir 24. The substantially equal split portions of the electrically-conductive fluid volume 62 merge through the residual volume of electrically-conductive fluid held in contact with electrode 18 to form a continuous electrically-conductive fluid volume 64. The distances between the electrode pairs and the volume of the electrically-conducting fluid are selected so that the contact points of electrodes 16, 20 remain covered by electrically-conducting fluid at all times during the switching operations. This feature protects the contact point surfaces of electrodes 16, 20 against possible corrosion or damage that otherwise might result from exposure to the electrically-insulating fluid. In this second state of electrical switch 50, the circuits defined by electrode pair 16, 18 and electrode pair 18, 20 are closed by electrically-conductive fluid volume 64, whereas the circuits defined by electrode pair 14, 16 and electrode pair 14, 20 are open as a result of the presence of electrically-insulating fluid between the electrodes of each electrode pair 14, 16 and 14, 20. Reservoirs 22, 24 are designed so that even after the bias has been removed from the heater 42, the surface tension of the electrically-conductive fluid volume 64 overcomes the pressure exerted by the gas inside the reservoir 24.

The electrical switch 50 may be switched back to the state of FIG. 3A, as follows. When a bias is applied to heater 44, electrically-insulating fluid inside reservoir 24 expands or undergoes a transition from the liquid phase to the vapor phase, producing a positive pressure with respect to reservoir 22. This positive pressure acts on the electrically-conductive fluid volume 64 through ports 58, 60, causing the electrically-conductive fluid volume 64 to split into three volumes: two substantially equal parts and a residual part that remains at electrode 18 to protect electrode 18 against exposure to electrically-insulating fluid. The split portions of the electrically-conductive fluid volume 64 are moved and deformed, forcing electrically-insulating fluid located between electrodes 14, 16 and electrodes 14, 20 into reservoir 22. The resulting split portions of the electrically-conductive fluid volume 64 merge through the residual volume of electrically-conductive fluid held in contact with electrode 14 to form the original continuous electrically-conductive fluid volume 62.

As shown in FIGS. 3A and 3B, in the illustrated embodiment, the quarter-wavelength electrical path produced by the electrically-conductive fluid volume 62 completely disappears due to the movement of the electrically-conductive fluid when the switch state changes to that of FIG. 3B. Similarly, the quarter-wavelength electrical path produced by the electrically-conductive fluid volume 64 completely disappears due to the movement of the electrically-conductive fluid when the state changes to that of FIG. 3A. This feature provides a Wilkinson divider of nearly ideal form, in which there is no capacitance component, extra open stubs, or the like near the electrodes 16, 20. Also, just as in the embodiment of FIGS. 1A-2B, the open or closed state of the switch is maintained by the surface tension of the conductive fluid even after the bias is removed from the heaters 42, 44.

In each of the above-described embodiments, the physical shape of the fluid channel 12 containing the electrically-conductive fluid volumes may be tailored so that the electrically-conductive fluid volumes have desired transmission line characteristics.

Other embodiments are within the scope of the claims. For example, although the above embodiments were described in connection with specific electrical switch configurations, these embodiments readily may be incorporated in different switch configurations (e.g., a single-pole, double-throw switch and a single-pole, single-throw switch).

What is claimed is:

1. An electrical switch, comprising:
a closed-loop fluid channel containing an electrically-conductive fluid and an electrically-insulating fluid;
multiple electrodes each in contact with fluid within the fluid channel at a respective location; and
a pressure control system operable to change relative fluid pressure within the fluid channel at locations between adjacent electrodes to control splitting of a contiguous region of electrically-conductive fluid electrically connecting a pair of adjacent electrodes and merging of split regions of electrically-conductive fluid.

2. The electrical switch of claim 1, wherein the pressure control system is operable to change relative fluid pressure within the fluid channel to control merging of split regions of electrically-conductive fluid to electrically connect a different pair of adjacent electrodes.

3. The electrical switch of claim 1, wherein the pressure control system is operable to simultaneously change fluid pressure within the fluid channel at locations between electrodes of each of two pairs of adjacent electrodes not sharing a common electrode.

4. The electrical switch of claim 1, wherein the pressure control system is operable to simultaneously change fluid pressure within the fluid channel at locations between electrodes of each of two pairs of adjacent electrodes sharing a common electrode.

5. The electrical switch of claim 1, wherein the fluid channel comprises at least two fluid ports each located between a respective pair of adjacent electrodes, and the pressure control system is coupled to control the flow of non-conducting fluid through the fluid ports.

6. The electrical switch of claim 5, wherein the pressure control system comprises a reservoir of electrically-insulating fluid coupled to a pair of fluid ports.

7. The electrical switch of claim 6, wherein the reservoir is coupled to a pair of fluid ports respectively located between electrodes of two pairs of adjacent electrodes not sharing a common electrode.

8. The electrical switch of claim 6, wherein the reservoir is coupled to a pair of fluid ports respectively located between electrodes of two pairs of adjacent electrodes sharing a common electrode.

9. The electrical switch of claim 6, wherein the reservoir is circumscribed by the fluid channel.

10. The electrical switch of claim 6, wherein the reservoir is located outside the fluid channel.

11. The electrical switch of claim 6, wherein the pressure control system comprises a heater operable to heat electrically-insulating fluid in the reservoir.

12. The electrical switch of claim 6, wherein the pressure control system comprises a second reservoir of electrically-insulating fluid coupled to a second pair of fluid ports.

13. The electrical switch of claim 5, wherein the fluid ports are configured to contain the electrically-conductive fluid in the fluid channel.

14. The electrical switch of claim 1, wherein each of a pair of non-adjacent electrodes is spaced from a third electrode by a distance corresponding to (4×f₁)⁻¹, where f₁ is a first target signal frequency.

15. The electrical switch of claim 14, wherein the non-adjacent electrodes are coupled together by a resistor having an impedance of \sqrt{2}×Z₀, where Z₀ is a characteristic impedance produced between the pair of non-adjacent electrodes when electrically-connected together by electrically-conductive fluid within the fluid channel.

16. The electrical switch of claim 14, wherein each of a pair of non-adjacent electrodes is spaced from a fourth electrode by a distance corresponding to (4×f₂)⁻¹, where f₂ is a second target signal frequency.

17. The electrical switch of claim 1, wherein the electrically-conductive fluid has a volume selected to prevent formation of parasitic transmission line elements at electrodes in an open state.

18. The electrical switch of claim 1, wherein the pressure control system is operable to split two volumes of electrically-conductive fluid electrically-connecting two pairs of electrodes and to merge the split electrically-conductive fluid volumes in other regions of the fluid channel to electrically connect two different pairs of electrodes.

19. The electrical switch of claim 1, wherein each of the electrodes has sufficient wettability with respect to the electrically conductive fluid to maintain electrically-conductive fluid over each of the electrodes during transitions from an open state to a closed state and vice versa.

20. An electrical switch, comprising:
a closed-loop fluid channel containing an electrically-conductive fluid and an electrically-insulating fluid and having four fluid ports;
four electrodes each in contact with fluid within the fluid channel at a respective location between a respective pair of adjacent fluid ports; and
two reservoirs of electrically-insulating fluid respectively coupled between a respective pair of non-adjacent fluid ports.

21. An electrical switch, comprising:
a closed-loop fluid channel containing an electrically-conductive fluid and an electrically-insulating fluid and having four fluid ports;
four electrodes each in contact with fluid within the fluid channel at a respective location between a respective pair of adjacent fluid ports; and
two reservoirs of electrically-insulating fluid respectively coupled between a respective pair of adjacent fluid ports.
